(19) United States
(12) Patent Application Publication
(10) Pub. No.: US 2005/0149264 A1
(43) Pub. Date: Jul. 7, 2005

(54) System and Method to Interpret Distributed Temperature Sensor Data and to Determine a Flow Rate in a Well

(75) Inventors: Jeffrey A. Tarvin, Brookfield, CT (US); Lalitha Venkataramanan, Ridgefield, CT (US); Thomas M. White, Spring, TX (US); George A. Brown, Beaconsfield (GB)

Correspondence Address: SCHLUMBERGER RESERVOIR COMPLETIONS, 14910 AIRLINE ROAD, P.O. BOX 1590, ROSHARON, TX, 77583-1590, US

(73) Assignee: Schlumberger Technology Corporation, Sugar Land, TX (US)

(21) Appl. No.: 10/711,918

(22) Filed: Oct. 13, 2004

Related U.S. Application Data
(60) Provisional application No. 60/533,188, filed on Dec. 30, 2003.
(60) Provisional application No. 60/536,059, filed on Jan. 13, 2004.

(51) Int. Cl. G06F 19/00

(52) U.S. Cl. 702/6

(57) ABSTRACT

A distributed temperature sensor is deployed in a wellbore and is functionally connected to a processor. The processor receives the data from the distributed temperature sensor and automatically processes the data to highlight valuable information to the user relating to the relevant well, completion, or reservoir. In one embodiment, the distributed temperature sensor and processor are utilized in a well containing a gas-lift system, wherein the processor highlights valuable information to the user pertaining to the gas-lift system. A well model enabled by the processor enables the determination of a produced fluid flow rate in the well having a gas lift system. Temperatures are measured within the well to obtain a temperature profile, and this profile is processed according to the well model. The well model relates thermal characteristics, e.g. thermal decay and/or amplitude of a thermal discontinuity at an injection point, to flow rate. The flow rate determined from the thermal characteristics is used to optimize production from the well.

### CROSS-REFERENCE TO RELATED APPLICATIONS

This application claims the benefit under 35 USC 119(e) of U.S. Provisional Patent Application Ser. No. 60/533188 filed 30 Dec. 2003 and U.S. Provisional Patent Application Ser. No. 60/536,059 filed 13 Jan. 2004.

### BACKGROUND

The invention generally relates to a system and method to interpret distributed temperature sensor data. More specifically, the invention relates, first, to a system and method to automatically interpret distributed temperature sensor data from a specific wellbore event, such as the thermal events typically present in a gas lift well, second, to a system and method to determine flow rates from temperature data obtained from a gas lift wellbore, and third, to a system and method to optimize production flow rates from temperature data obtained from a gas lift wellbore.

Distributed temperature sensors, such as Sensor Highway Limited's DTS line of fiber optic distributed temperature sensors, have been used to measure the temperature profile of subterranean wellbores. In the DTS systems, an optical fiber is deployed in the wellbore and is connected to an opto-electronic unit that transmits optical pulses into the optical fiber and receives returned signals back from the optical fiber. Depending on the type of wellbore and on the service or completion, the optical fiber may be deployed in a variety of ways, such as part of an intervention service, permanently inside of a tubing (such as a production tubing), or permanently installed in the annulus between the borehole wall and the tubing. The signal reflected from the optical fiber and received by the opto-electronic unit differs depending on the temperature at the originating point of the reflected signal.

Sensor Highway's DTS system utilizes a technique called optical time domain reflectometry (“OTDR”), which detects Raman scattering to measure the temperature profile along the optical fiber as described in U.S. Pat. Nos. 4,823,166 and 5,592,282 issued to Hartog, both of which are incorporated herein by reference. For purposes of completeness, OTDR will now be described, although it is understood that OTDR is not the only way to obtain a distributed temperature measurement (and this patent is therefore not limited to OTDR).

In OTDR, a pulse of optical energy is launched into an optical fiber and the backscattered optical energy returning from the fiber is observed as a function of time, which is proportional to distance along the fiber from which the backscattered light is received. This backscattered light includes the Rayleigh, Brillouin, and Raman spectra. The Raman spectrum is the most temperature sensitive with the intensity of the spectrum varying with temperature, although Brillouin scattering and in certain cases Rayleigh scattering are also temperature sensitive. Generally, in one embodiment, pulses of light at a fixed wavelength are transmitted from a light source down the fiber optic line. Light is back-scattered along the length of the optical fiber and returns to the instrument. Knowing the speed of light and the moment of arrival of the return signal enables its point of origin along the fiber line to be determined. Temperature stimulates the energy levels of molecules of the silica and of other index-modifying additives—such as germania—present in the fiber line. The back-scattered light contains upshifted and downshifted wavebands (such as the Stokes Raman and Anti-Stokes Raman portions of the back-scattered spectrum) which can be analyzed to determine the temperature at origin. In this way the temperature along the fiber line can be calculated by the instrument, providing a complete temperature profile along the length of the fiber line. Different temperature profiles can also be obtained in time, thereby providing a time lapsed temperature profile along the entire length of the optical fiber.

The temperature profiles that are obtained from distributed temperature sensors such as the DTS can then be used by operators to, among others, measure flow rate, identify the presence and location of leaks, or identify the extent and success of an injection operation. However, the temperature profiles obtained from distributed temperature sensors such as the DTS generate a very large amount of data per time profile. This data is currently typically reviewed manually, at least at some point during the analysis. Reviewing this data manually in order to analyze and extract value from the data is a time consuming and highly specialized operation.

For instance, the temperature profiles generated from distributed temperature sensors are very useful in gas-lift operations. Gas expands abruptly where it enters production tubing. This expansion produces significant cooling through the Joule-Thomson effect. Consequently, the temperature profiles can reveal where, when, and to what extent gas is injected (i.e. the location and operation of a gas lift valve). However, the temperature profile often fluctuates in gas lift wells. Although the temperature change at an injection point may be several degrees Centigrade, the presence of fluctuations, the exceedingly high number of temperature data points, and the broad temperature trend in the well may obscure the change. Thus, it takes an operator a substantial amount of time to manually identify the sections of the temperature profile that contain valuable information and to then remove or suppress the background or non-relevant temperature phenomena from the valuable information in the temperature profile. Manual analysis introduces subjectivity, cannot be automatically integrated with use of other algorithms, and may provide inaccurate analysis due to noise or temperature trends that obscure the signal to a human operator. Furthermore, the ability to obtain production flow related information from the distributed temperature sensor data or other temperature data has been limited.

Thus, there is a continuing need to address one or more of the problems stated above.

### SUMMARY

A distributed temperature sensor is deployed in a wellbore and is functionally connected to a processor. The processor receives the data from the distributed temperature sensor and automatically processes the data to highlight valuable information to the user relating to the relevant well, completion, or reservoir. In one embodiment, the distributed temperature sensor and processor are utilized in a well containing a gas-lift system, wherein the processor highlights valuable information to the user pertaining to the gas-lift system. A well model enabled by the processor enables the determination of a produced fluid flow rate in the well having a gas lift system. Temperatures are measured within the well to obtain a temperature profile, and this profile is processed according to the well model. The well model relates thermal characteristics, e.g. thermal decay and/or amplitude of a thermal discontinuity at an injection point, to flow rate.

Advantages and other features of the invention will become apparent from the following drawing, description and claims.

### BRIEF DESCRIPTION OF THE DRAWING

FIG. 1 is a schematic of a well completion utilizing the present invention, including a distributed temperature sensor and a processor.

FIG. 2 is a schematic of one embodiment of the processor.

FIG. 3 is a flow chart of one algorithm that may be performed by the processor.

FIG. 4 is a schematic of a well completion with a gas lift system utilizing the present invention.

FIGS. 5-10 are flow charts of different parts or embodiments of algorithms that may be performed by the processor.

FIGS. 11-16 are plots that may be presented to an operator to illustrate the results of the operations performed by the processor.

FIGS. 17-22 are flow charts representing algorithms and specific portions of those algorithms according to alternate embodiments of the present invention.

FIGS. 23-24 are flow charts representing an algorithm for optimizing gas-lift performance of a well.

### DETAILED DESCRIPTION

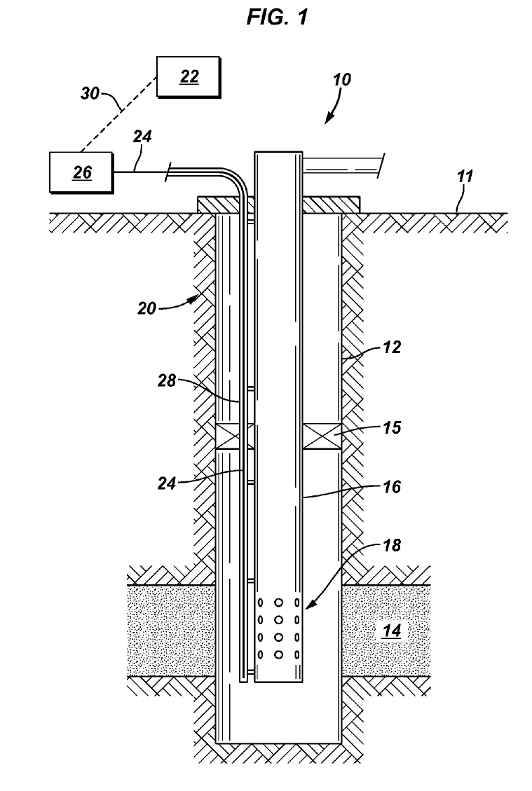

FIG. 1 illustrates an embodiment of a system 10 that is the subject of this invention. A wellbore 12 extends from the surface 11 into the earth and intersects a formation 14 that contains fluids, such as hydrocarbons. The wellbore 12 may be cased. A tubing 16, such as a production tubing, extends within the wellbore 12. A packer 15 provides a seal and isolates the formation 14 from the region above the packer 15. Depending on whether the wellbore 12 is used as an injector well or as a producing well, fluid is either injected into the tubing 16 and into the formation 14 or fluid is produced from the formation 14 and into the tubing 16. In either case, fluid enters or exits the tubing 16 through flow paths in the tubing 16, such as the ports 18 illustrated in FIG. 1. The injection and production of fluids may also be aided by artificial lift mechanisms, such as pumps or gas lift valves. Perforations (not shown) may also be made in the wellbore 12 at the formation 14 in order to facilitate the flow of fluids into or out of the formation 14.

The system 10 includes a distributed temperature sensor system 20 and a processor 22. The sensor system 20 comprises an optical fiber 24 deployed in the wellbore 12 and an opto-electronic unit 26 typically but not necessarily located at the surface 11. The optical fiber 24 is connected to the unit 26 and can be used to measure temperature simultaneously at multiple depths. In one embodiment, the optical fiber is deployed within a control conduit 28, such as a 0.25″ control line. The conduit 28 may be attached to the tubing 16. Although the conduit 28 is shown attached to the exterior of tubing 16, conduit 28 (and optical fiber 24) may instead be inside of tubing 16 or may be cemented in place to the outside of the casing (not shown). In one embodiment, the optical fiber 24 is injected into the conduit 28, which may also be u-shaped, by way of fluid drag, as disclosed in U.S. Pat. No. Re 37283, which patent is incorporated herein by reference. The optical fiber 24 also may be implemented as a temporary distributed temperature sensor installation or as a slickline distributed temperature sensor system.

As previously disclosed, the unit 26 launches optical pulses into the optical fiber 24 and backscattered light is returned from the optical fiber 24. The backscattered light signals include information which can provide a temperature profile along the length of the optical fiber 24. For the configuration of FIG. 1, the temperature profiles generated by the system 10 may be used to detect whether fluids are flowing from the formation 14 and into the tubing 16 or to detect the extent and success of an injection operation from the tubing 16 and into the formation 14.

Processor 22 automatically analyzes the temperature profile data to minimize or remove any non-relevant temperature “noise” and to focus on the data points or sections that contain valuable information. As will be described, the processor 22 may also be programmed by an operator to “identify” particular temperature signals that typically correspond to a particular downhole event having an inflow of cooler fluid, e.g. gas, into a flowing stream, e.g. a flowing stream of oil or oil, water and gas mixtures. These types of events indicate, for example, the location of a gas lift valve, a hole in the production tubing, general wellbore completion tool leaks (e.g. packer leaks, sliding sleeve leaks, collar leaks) or the inflow of fluids from a formation that are cooler than the fluid flowing in the wellbore. The cooler temperatures typically are due to Joule-Thompson expansion of the inflowing fluid at or near the inflow point and indicate the magnitude of the inflow to the continuous flow stream and whether it is a continuous or transient event.

The processor 22 is connected to the unit 26 by way of a communication link 30. The communication link 30 can take various forms, including a hardline, e.g. a direct hard-line connection at the well site, a wireless link, e.g. a satellite connection, a radio connection, a connection through a main central router, a modem connection, a web-based or internet connection, a temporary connection, and/or a connection to a remote location such as the offices of an operator. The communication link 30 may enable real time transmission of data or may enable time-lapsed transmission of data. The data transmission and processing allow a user to monitor the wellbore 12 in real time and take immediate corrective action based on the data received or analysis performed. In other words, processor 22 is able to process the data as it is received, enabling a controller/operator to make real-time decisions.

Processor 22 may be a portable computer that can be removably attached from the unit 26. With the use of a portable computer, a user may analyze various wellbores while using a single computer system. Processor 22 may be a personal computer or other computer.

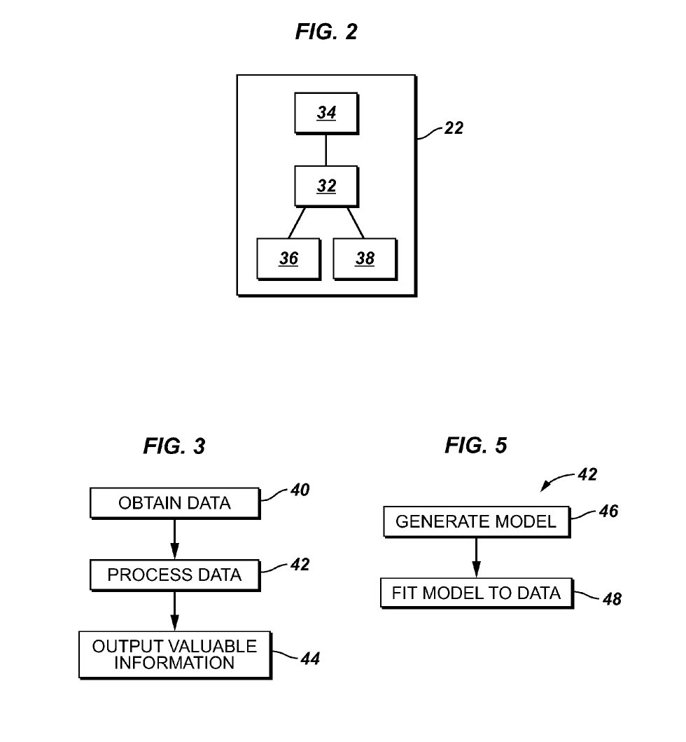

FIG. 2 illustrates in block diagram form an embodiment of hardware that may be used as the processor 22 and to operate the representative embodiment of the present invention. The processor 22 comprises a central processing unit (“CPU”) 32 coupled to a memory 34, an input device 36 (i.e., a user interface unit), and an output device 38 (i.e., a visual interface unit). The input device 36 may be a keyboard, mouse, voice recognition unit, or any other device capable of receiving instructions. It is through the input device 36 that the user may make a selection or request as stipulated herein. The output device 38 may be a device that is capable of displaying or presenting data and/or diagrams to a user, such as a monitor. The memory 34 may be a primary memory, such as RAM, a secondary memory, such as a disk drive, a combination of those, as well as other types of memory. Note that the present invention may be implemented in a computer network, using the Internet, or other methods of interconnecting computers. Therefore, the memory 34 may be an independent memory 34 accessed by the network, or a memory 34 associated with one or more of the computers. Likewise, the input device 36 and output device 38 may be associated with any one or more of the computers of the network. Similarly, the system may utilize the capabilities of any one or more of the computers and a central network controller. Therefore, a reference to the components of the system herein may utilize individual components in a network of devices. Other types of computer systems also may be used. Therefore, when reference is made to “the CPU,” “the memory,” “the input device,” and “the output device,” the relevant device could be any one in the system of computers or network.

FIG. 3 shows in flow chart form the operations performed by the processor 22. In the first step 40, the processor 22 obtains the distributed temperature sensor data (i.e. the temperature profiles) from the unit 26 via the communication link 30 as previously disclosed. In step 42, the processor 22 processes the data to remove noise and/or focus on significant events to thereby extract the valuable information from the data. In step 44, the valuable information is provided as an output in the format chosen by the user through the output device 38.

The process data step 42 can take on a variety of forms, depending on the desire of the operator and on the configuration of the wellbore being analyzed (i.e. gas lift, water injection, producer, horizontal). In one embodiment, the process data step comprises the use of an algorithm to process the temperature profile data to remove noise from the data and/or focus on significant events. Generally, the algorithms that may be used to achieve these functions include the removal of low order spatial trends (e.g. a polynomial in depth can be fit to each temperature profile and the resulting function can be subtracted from the profile), a high-pass filter (such as one that removes low spatial frequencies like a sixth-order, zero-phase Butterworth filter), the differentiation of data with respect to an independent variable (such as depth), low pass filters, matched filters (functions with shapes similar to what is expected in the data), adaptive filters, wavelets, background subtraction, Bayesian analysis, and model fitting. These algorithms can be applied to the data individually, or in combination. For example, filtering can identify important regions of the data and then trend removal can be used for further processing. Moreover, the algorithms can be applied in measured depth or in time. It should be noted the algorithm may be applied to other applications, such as detection of carbon dioxide or steam flood in production wells and to identify other events having a large Joule-Thompson effect.

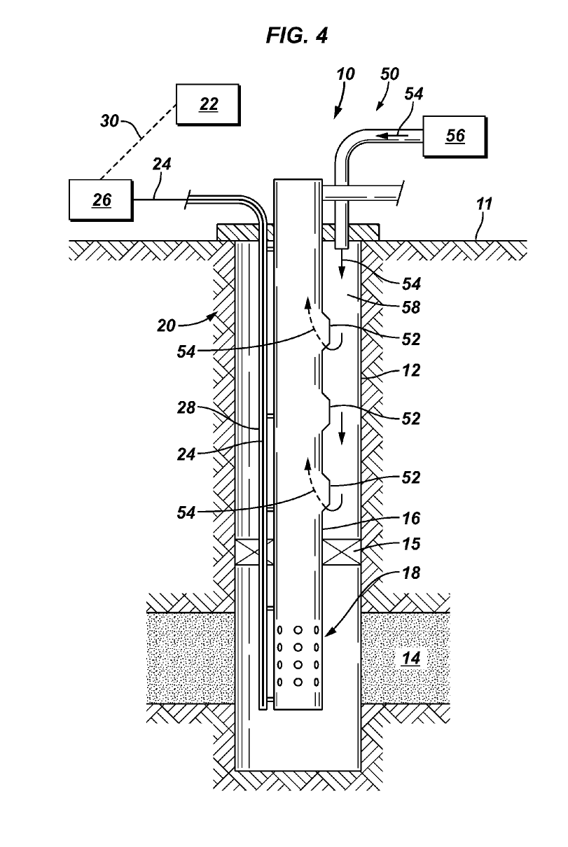

An example of how the model fitting algorithm may be used to analyze a gas-lift well will now be described with reference to FIG. 4. FIG. 4 illustrates the wellbore 12 including a gas lift system 50 disposed therein. Gas lift system 50 may comprise at least one gas lift valve 52 disposed on tubing, such as production tubing 16. Gas lift is a common method for providing artificial lift to oil wells and involves injecting gas 54 from a source 56 into the annulus 58 through the valves 52 and into tubing 16. The valves 52 are typically pressure-controlled, with only the deepest valve 52 open during normal operation. Shallower valves are opened to start the well flowing. The gas reduces the average density in the production column by displacing oil and water. Thus, the gas injection increases production by reducing the pressure at the bottom of the well.

The design of the gas-lift system 50 is matched to the productive capacity of the well. Design parameters include gas-injection pressure and rate, tubing diameter, valve depths and operating pressures, and orifice diameters of the valves. However, equipment failures, changes in a well's in-flow capacity, or changes in water-cut can reduce the effectiveness of the gas-lift system. Because gas injection often causes large fluctuations in production, traditional production logging tools, which measure at each depth at a different time, can provide ambiguous data. Consequently, diagnosing problems in gas-lift wells is difficult. The time-lapsed temperature profiles generated by distributed temperature sensors are particularly suited and beneficial for this diagnosis.

The use of the model fitting algorithm to analyze a gas-lift system 50 achieves the following: [1] it removes the irrelevant aspects of the temperature profile data and suppresses noise, [2] it tolerates the rapid temperature fluctuations in space and time that are typical in gas-lift wells,
it tolerates the possibility that the gas signature may be limited to a small region or spread out over a large one, [4] it minimizes input from an operator thereby reducing training requirements and the staff time that must be devoted to processing, and [5] it processes the data rapidly making it useful in temporary (and not only permanent) distributed temperature sensor installations.

With the model fitting algorithm, a model of at least part of the wellbore or its performance is fit to the temperature profile data by adjusting parameters in the model. As illustrated in FIG. 5, the process data step 42 in this embodiment comprises generating the model at step 46 and then fitting the model to the data at step 48.

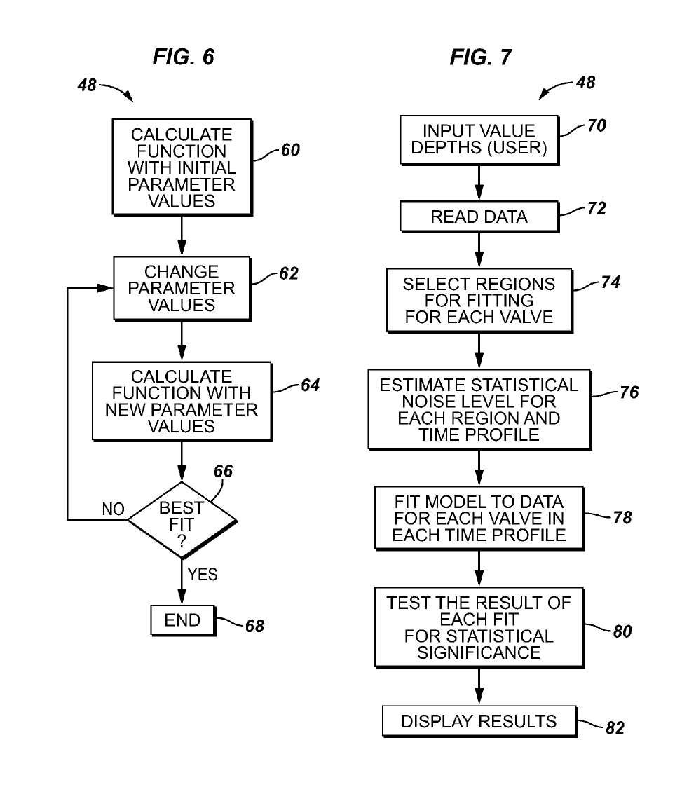

One embodiment of the fitting the model to the data step 48 is shown in FIG. 6. In this embodiment, the model's function is calculated with initial parameter values that may be estimated at step 60. Then, at step 62, the parameter values are changed (unless it is the first iteration including the initial parameter values). At step 64, the model's function is calculated with the new parameter values. And, at step 66, the current model calculation and the subsequent model calculation are compared and the one that provides the better fit to the temperature profile data is stored. The iteration then continues until further modifications of model parameters no longer make the fit significantly better, at which point the initial model of that iteration is deemed to be the best fit for the temperature profile data. The definition of best fit may be preprogrammed by a user.

In one embodiment, the model comprises a comprehensive model for the physical gas-lift system. In another embodiment, the model comprises a phenomenological model.

With respect to the use of a phenomenological model, the basic assumption of the model may be that gas injection causes a local perturbation of temperature and that the perturbation decreases exponentially in either direction from the point of injection. Because flowing fluids convect heat, the decay length is greater in the downstream (up the well) direction. The model is fit to a range around each valve. The model has four primary parameters for each valve: the depth of injection in the wellbore (i.e. approximate valve depth), the amplitude of the temperature effect (i.e. how much temperature difference is caused by the injection), and the decay length in each direction from the injection depth. The model also includes two secondary parameters for each valve, a slope and an intercept, to account for a linear background temperature variation. The model adjusts the parameters to match the data at each valve in each temperature profile. When the distance between valves is sufficient, the valves are treated independently because the effect at one valve caused by another is smooth and can be considered part of the background. Otherwise, valves that are close together may be grouped for simultaneous analysis. The algorithm uses the Levenberg-Marquardt method, discussed in D W Marquardt, J. Soc. Industrial and Applied Mathematics, vol. 11, p. 131 (1963), to solve the non-linear fitting problem. The algorithm also tests the fit at each valve in each profile for statistical significance. If a fit is not considered significant, the temperature amplitude is set to zero and other parameters are set to default values.

A function that may be utilized for the phenomenological model described above is the following modification of one derived by Ramey (H. J. Ramey, “Wellbore heat transmission,” J. Petroleum Technology, p 427 (1962)) for the thermal signature of fluids pumped down a well:

$${T}_{j} = A exp ( - \frac{\vert {z}_{j} - d \vert}{{l}_{i}} ) + a + {bz}_{j} \qquad Equation 1$$

wherein A is the amplitude of the temperature effect, zⱼ is the depth measured from the surface (a position depth variable), d is the approximate valve depth, a is the background intercept, and b is the background slope. If zⱼ exceeds d, then lᵢ is the upstream (down the well) decay length and the downstream (up the well) decay length is ignored. If zⱼ is less than d, then lᵢ is the downstream (up the well) decay length and the upstream (down the well) decay length is ignored.

FIG. 7 illustrates in flow chart form the algorithm used to solve the phenomenological model with use of Equation 1. In the first step 70, the user is prompted for and the user inputs the approximate depth of each gas lift valve. The temperature profile data from the distributed temperature sensor is then read in step 72. In the third step 74, the algorithm selects a region for fitting for each valve. In this step 74, the algorithm sets up a window of data to analyze above and below the approximate valve depth inputted in step 70 for each valve. In the next step 76, the statistical noise level in each region selected in step 74 is estimated for each time profile of temperature data. The model is then fit to the actual data for each valve and for each time profile of temperature data in step 78. Next, in step 80, the result of each fit is tested for statistical significance to ensure the fit is an actual and not a computer-created event. Lastly, in step 82, the results are displayed in ways that are beneficial and valuable to the user.

Although the algorithm illustrated in FIG. 7 prompts the user for the approximate valve depth in step 70, in another embodiment the algorithm automatically locates the location of each valve by interpreting and analyzing the data from the distributed temperature sensor. Given the typical gas-lift valve signature, a matched filter may be used by the processor 22 to locate each valve.

Step 76 (Estimate Statistical Noise Level For Each Region And Time Profile) is further illustrated in FIG. 8. First, in step 84, regions very near to each valve are omitted and the remaining data are sub-divided by depth into groups. Next, in step 86, the linear trends are removed from the data in each of those groups. In step 88, the power spectrum of the relevant data is estimated in each group. And then, in step 90, the baseline in the power spectrum is estimated as the statistical noise level for that group. In step 91, a smooth curve is fit to the noise level versus depth, and the noise level for the depth of each valve is taken from the smooth curve.

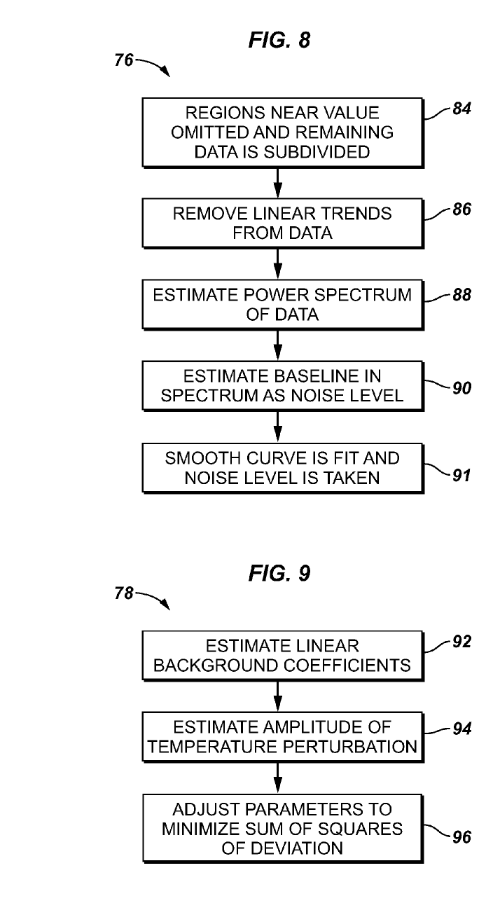

Step 78 (Fit Model To Data For Each Valve In Each Time Profile) is further illustrated in FIG. 9. In the first step 92, the linear background coefficients from Equation 1 (a and b) are estimated, such as by selecting random starting points for each or by selecting a line with a given slope as a starting point. In the next step 94, the amplitude of the temperature perturbation caused by the injection is estimated by analyzing the temperature data. Then, in step 96, the six parameters of Equation 1 are adjusted to provide the best fit to the actual temperature data, such as by using the sum of squares of deviations method.

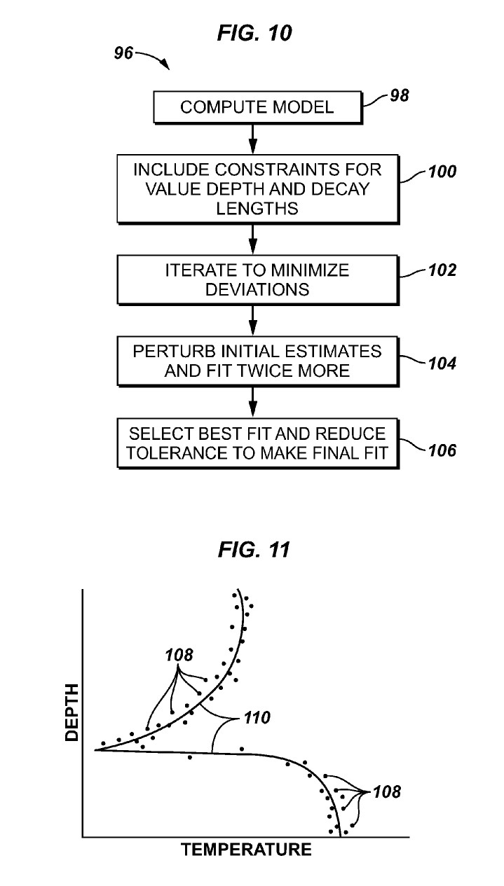

Step 96 (Adjust Parameters To Minimize Sum Of Squares Of Deviations) is further illustrated in FIG. 10. In the first step 98, the model is computed using the initial values for the various parameters. Next, in step 100, constraints for valve depth and decay lengths are taken into account to ensure that such parameters are not iterated to be outside of certain ranges. For instance, in one embodiment, a constraint is placed on the valve depth parameter to ensure that it remains within the region selected in step 74 of FIG. 7. And, a constraint is placed on the decay lengths to ensure that such values are always positive (not negative or 0). In the next step 102, the values of each of the parameters are iterated with the goal of minimizing deviations. In step 104, the initial parameter estimates or values are perturbed or changed again, and preferably twice more, and the iteration process is rerun for each perturbation. This step 104 ensures that the global and not just a local minimum is generated as a result of the iteration process. In the last step 106, the best fit from each of the iteration sequences is selected as the best overall fit and the tolerance is reduced to make the final fit.

It should be noted that the goal of step 80 (see FIG. 7) is to reduce the number of non-events that are incorrectly identified as events (“false positives”) and to reduce the number of events that are incorrectly ignored (“false negatives”). In one embodiment, step 80 comprises comparing competing models. An appropriate competing model to the phenomenological model previously described is a low-order polynomial. Although the downstream temperature decay length for gas injection may range from a few meters to hundreds of meters, the upstream decay length should be limited to a few meters. Thus, an event has some temperature variation that occurs over a short distance. Non-events that the model may fit result primarily from the convection of temperature disturbances up the well. The sharp features of a temperature fluctuation smooth out as it travels. Since a low-order polynomial is smoother than the target model, it fits most convected features better. The residual variance, that is, the sum of squares of the differences between data and a model, is a common measure of the quality of a fit—the smaller the variance is, the better the fit. If the variance for the phenomenological model is smaller than that for the polynomial, the phenomenological model may be regarded as significant. In one embodiment, one may require that the variance of the polynomial model be larger by some fraction of the noise level. In another embodiment, the required fraction may be reduced when adjacent profiles have significant fits.

In step 82 of FIG. 7, the results are displayed to the user. FIG. 11 illustrates one plot that may be useful to a user. The plot is depth versus temperature and the points 108 on the plot are the raw temperature profile data points obtained from the distributed temperature sensor near one of the gas lift valves at one particular time. The curve 110 on the plot is the curve derived from the phenomenological model and algorithm previous described that best fits the points 108. A review of this plot would enable a user to visualize the accuracy of the fitting, which in the case illustrated is good.

The user may also want to view the pure temperature perturbation created by the injection at a specific valve without the background linear trend. In order to plot this pure perturbation, the background parameters (a and b) are removed from Equation 1, giving:

$${T}_{j} = A exp ( - \frac{\vert {z}_{j} - d \vert}{{l}_{i}} ) \qquad Equation 2$$

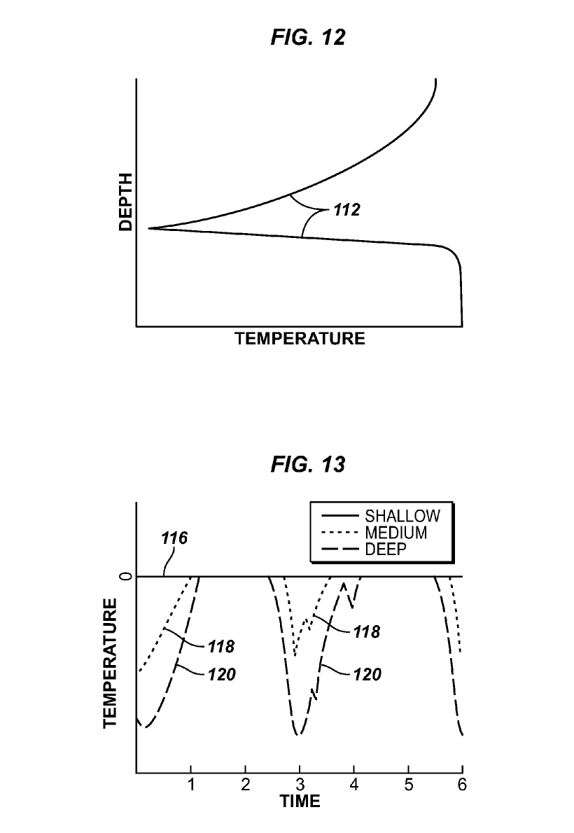

and Eq. 2 is solved using the values of the parameters that provided the best fit to the actual temperature profile data points (such as those used to plot curve 110 in FIG. 11). FIG. 12 shows at curve 112 what could be the plot of the pure temperature perturbation of the data plotted and fitted in FIG. 11.

The amplitude of the temperature effect generated by the injection at each valve can also be plotted, as shown in FIG. 13. In FIG. 13, it is assumed that there are three valves, a shallow valve, a deep valve, and a medium valve located between the shallow and deep valve. The straight line curve 116 of FIG. 13 shows that no temperature effect is occurring at the shallow valve and therefore it is likely that no injection is occurring at such valve. The dotted line curve 118 of FIG. 13 shows that some temperature effect is occurring intermittently at the medium valve. The dashed line curve 120 of FIG. 13 shows that a temperature effect greater than that of the medium valve is intermittently occurring at the deep valve. The deep and medium valves are the more important valves, since the shallow valve shows no temperature effect. Generally, the amplitude of the perturbation is highest when production fluid is stationary because the gas cools the same fluid over a long period of time. Consequently, amplitude alone is a poor indicator of injection rate.

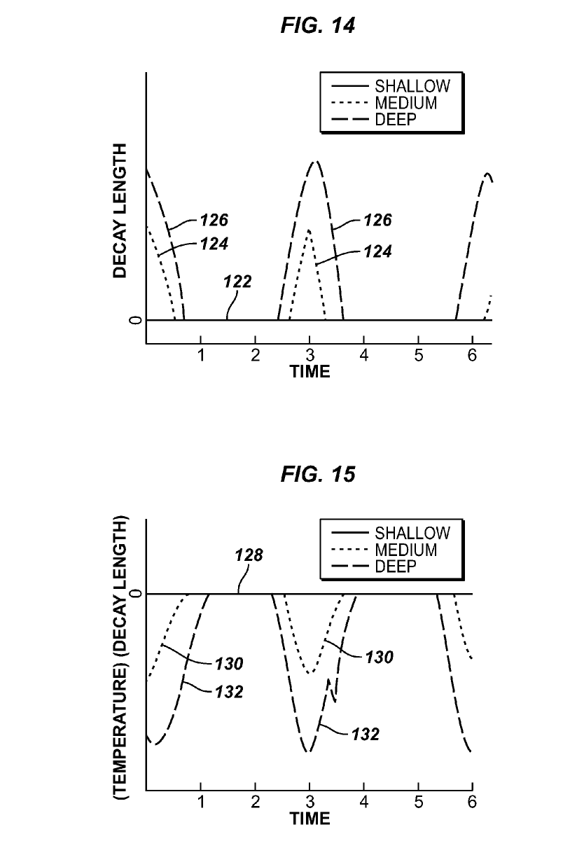

The downstream decay length for each valve is also a useful illustration for an operator. Typically, if the production fluid is moving, it carries the temperature perturbation up the well. The distance that the perturbation persists before disappearing increases with increasing flow rate. FIG. 14 shows an example plot of decay lengths versus time for each of the valves: shallow valve (straight line curve 122) medium valve (dotted line curve 124), and deep valve (dashed line curve 126). Note that the decay length increases at the beginning of each cycle for the two flowing valves, reaches a maximum, and stays at the maximum briefly before injection stops.

As previously stated, the amplitude alone (see FIG. 13) is a poor indication of injection rate. A better qualitative indicator of gas injection rate is the product of amplitude and downstream decay length. As with the flow rate, the injection rate increases early in the cycle. However, the injection rate starts to decline before the end of the cycle. FIG. 15 illustrates a plot of the product of amplitude and downstream decay length versus time for each of the valves:
shallow valve (straight line curve 128) medium valve (dotted line curve 130), and deep valve (dashed line curve 132).

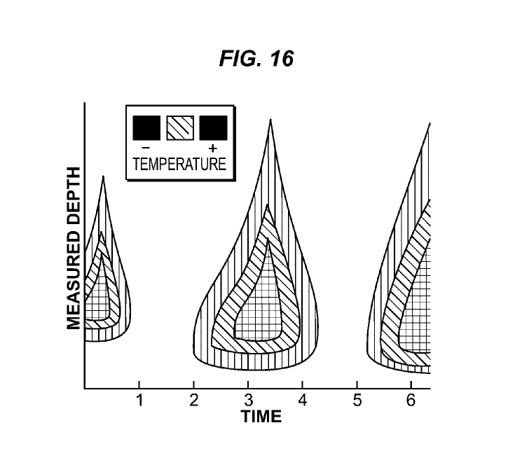

Contour plots can be particularly useful for an operator to analyze the performance of each valve at a time. FIG. 16 shows such a contour plot of one of the valves, for instance the deep valve. With a contour plot that plots temperature versus time and measured depth, an operator can analyze where and when injection is occurring at a particular valve, as well as the extent of such injection.

In operation, data from the distributed temperature sensor 20 is sent to the processor 22 via the communication link 30. The processor 20, which is loaded with the relevant algorithm or model, analyzes the temperature profile data itself to minimize or remove any non-relevant temperature “noise” and to focus on the data points or sections that contain valuable information. Representative algorithms are illustrated in FIGS. 3, 5, and 6-10. The inclusion of the processor 22 minimizes operator involvement in the analysis. Depending on the embodiment of the algorithm or model used in the processor 22, the user may be prompted by the processor 22 to answer certain questions, such as the approximate location of gas lift valves. The processor 22 then presents the results of the analysis to the user so as to highlight the valuable information that was extracted from the data by the processor 22. Examples of useful plot presentations are shown in FIGS. 11-16.

The use of the present invention in relation to gas-lift systems, such as the one shown in FIG. 4, can be particularly beneficial. The present invention enables an operator to determine the location, time, and extent of gas injection (i.e. the location and operation of gas lift valves) in a wellbore.

Having the results of the present invention on hand, an operator can then diagnose problems with the well, such as leaking or non-operating valves or valves with sub-optimal characteristics.

Although the gas-lift operation was described, it is understood that the present invention may be used for other types of operations, such as identification of cross flow between reservoir intervals at different reservoir pressures when the well is shut in, identification of gas inflow from the formation through perforated intervals, wellbore communication investigation, steam floods, water profiles, optimizing sampling processes and timing, and determining fracture height.

As previously described, instructions of the various routines discussed herein (such as the method and algorithm performed by the processor 22 and subparts thereof including equations and plots) may comprise software routines that are stored on memory 34 and loaded for execution on the CPU 32. Data and instructions (relating to the various routines and inputted data) are stored in the memory 34. The memory 34 may include semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and
optical media such as compact disks (CDs) or digital video disks (DVDs).

In an alternate embodiment, the algorithm discussed above is modified to further identify the depths of injection valves or other gas-injection events rather than using known injection valve depths. Specifically, a match filter is constructed with the shape that is characteristic of a gas-injection event. The algorithm processes temperature profiles to identify candidate depths where gas appears to be injected. The algorithm discussed above (see, for example, FIG. 7 and its associated description), can then be used to process the profiles at the candidate depths. However, minor modifications to the previously discussed algorithm can be made, as discussed below.

The new algorithm builds a match filter having characteristics expected from gas injection, e.g. a sharp change in temperature on the upstream (deep) side of the event and a more gradual decay on the downstream side. The mathematical convolution of the filter with a profile indicates candidate depths.

It should be noted that standard forms of matched filters may be modified to accommodate use with distributed temperature sensor temperature profiles. Normally, matched filters maximize the output signal-to-noise ratio in a filtering system when the noise satisfies certain characteristics, and the most important requirement is that the power spectrum of the noise be independent of frequency. Distributed temperature sensor profiles can violate this requirement. In such systems, the dominant part of the noise tends to be the background trend that varies slowly in space. Consequently, the spectrum of the noise is inversely proportional to spatial frequency at low frequencies. To suppress the background trend, terms can be added to the filter to make it orthogonal to the background. In one embodiment, constant and linear terms make the filter orthogonal to linear background trends. In this example, a final modification to the filter is normalization. The amplitude of the convolution should be unity when the profile has an injection signature with unit amplitude.

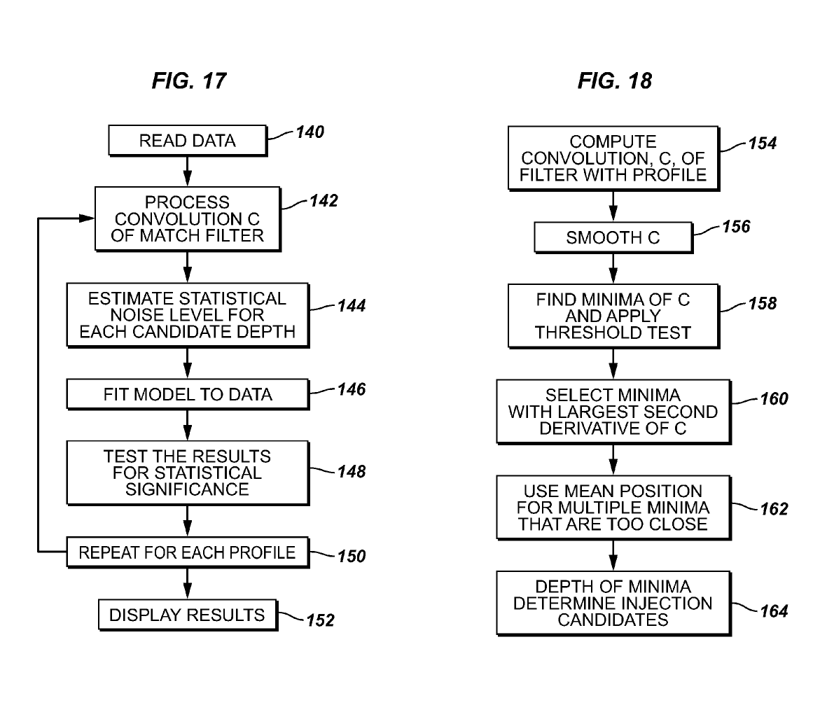

With the addition of the match filter, an identification algorithm is illustrated in flow chart form in FIG. 17. The identification algorithm is similar to the algorithm described above with reference to FIGS. 7-11 with several modifications. In an initial step 140, temperature profile data is read by the system, e.g. a system processor, when the data is received from, for example, a distributed temperature sensor. In a next step 142, the system processes convolution C of the match filter with a temperature profile. In a next step 144, an estimate is made of the statistical noise level for each candidate depth. The model is then fit to the actual data for each candidate depth, as set forth in step 146. In a next step 148, the results for each candidate depth are tested for statistical significance. Steps 142, 144, 146 and 148 are repeated for each profile, as set forth in step 150. Subsequently, in step 152, the results may be displayed in one or more ways that are beneficial and/or valuable to the user.

Many of these steps have been described above with reference to FIGS. 7-11, but there are several differences. First, processing convolution C of the match filter (step 142) is different. In the previous algorithm, all temperature profiles are processed for a particular injection depth at one time. In the algorithm discussed with reference to FIG. 17, the candidate depths vary from temperature profile to temperature profile, and each profile is processed individually. The convolution step for a temperature profile can be described with reference to the flow chart illustrated in FIG. 18.

Initially, in step 154, the system computes convolution C of the match filter with a temperature profile. It should be noted that at shallow depths, temperature profiles often have significant anomalies. Accordingly, the algorithm may be designed to ignore initial distances, e.g. the first 500 meters of depth. Although the convolution smooths the data, point-to-point fluctuations may still be too large. Accordingly, C may be further smoothed with, for example, a Savitzky-Golay filter (see W. H. Press et al., Numerical Recipes in C, 2nd Ed., page 650, Cambridge University Press, New York (1992)), as illustrated in step 156.

In a next step 158, local extrema are located where the first derivative of the smoothed convolution changes sign. When the filter is normalized as described above, the convolution with a cooling event is negative. Thus, local minima, where the second derivative is positive, are selected from the extrema. A threshold test is applied. For example, the magnitude of the convolution must exceed a threshold for a particular minimum to be accepted, and the convolution must increase by another threshold in the vicinity of the minimum. The number of minima that satisfy the threshold tests is usually small. If there are too many minima, the system selects minima having the largest second derivative of C, as set forth in step 160. Those with a smaller second derivative are eliminated.

In a subsequent step 162, a mean position is used for multiple minima that are too close. Specifically, if minima occur too close to one another, the procedure for fitting multiple injection candidates simultaneously may not converge. Thus, when the separation of a group of candidates is too small, a single candidate at the mean depth replaces the group. The depths of the minima determine the injection candidates, as set forth in step 164. The minima that pass all the tests are the injection candidates that undergo further processing via the algorithm illustrated in FIG. 17.

Referring again to FIG. 17, subsequent to processing convolution C in step 142, the system estimates the statistical noise level for each candidate depth in step 144.

Algorithm steps 146 and 148 can be performed similar to steps 78 and 80 described above and illustrated in FIG. 7. Furthermore, the results may be displayed in, for example, graphical form and showing ranges of depths in which events are clustered.

The present invention may be used with land as well as subsea wellbores, including subsea wellbores with subsurface gas-lift installations.

Moreover, the results of the present invention may be combined with other measurements to analyze a well's performance more thoroughly and to help decide how to improve performance. For instance, the present invention may be combined with measurements of flow rate or pressure.

As previously described, instructions of the various routines discussed herein (such as the method and algorithm performed by the processor 22 and subparts thereof including equations and plots) may comprise software routines that are stored on memory 34 and loaded for execution on the CPU 32. Data and instructions (relating to the various routines and inputted data) are stored in the memory 34. The memory 34 may include semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

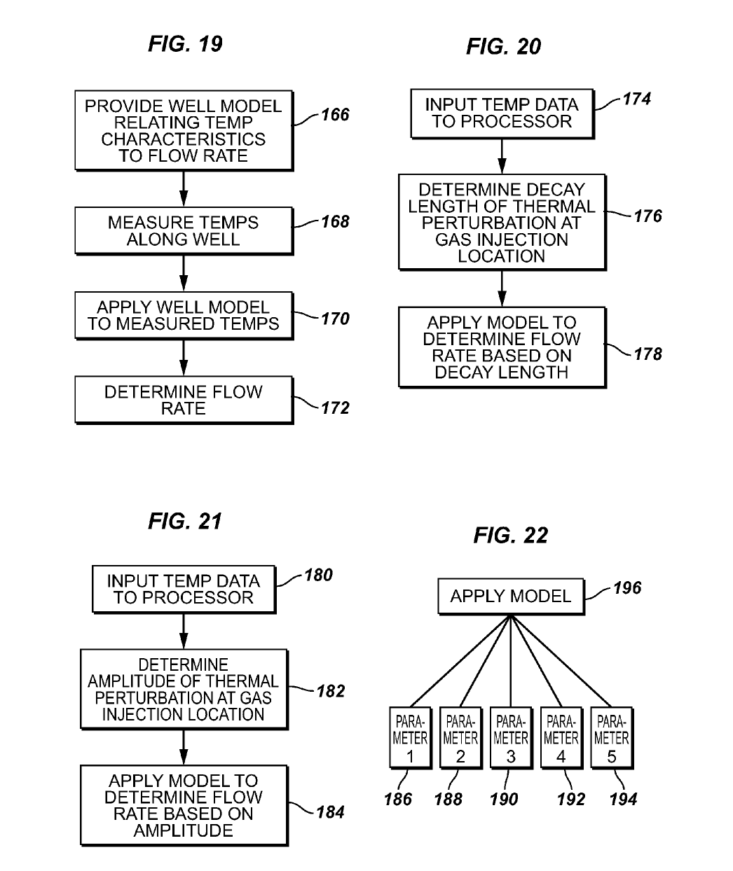

In the following embodiment, models/algorithms are provided for indicating a flow rate of a fluid produced through production tubing 16. As illustrated in FIG. 19, the fluid flow rate is modeled via a specific well model relating temperature characteristics to the flow rate through tubing 16 (see block 166). Once the model is established, temperatures may be measured along the well (see block 168) with, for example, distributed temperature sensor 20. The measured temperatures are applied to the well model (see block 170) which utilizes the temperature characteristics to determine a fluid flow rate (see block 172).

The algorithms discussed above with reference to FIGS. 1-16 can be used to identify where and when gas is injected into tubing 16 from the casing/tubing annulus of a gas-lift well. Those algorithms fit an exponential function to the spatial distribution of the temperature perturbation caused by gas injection. As is discussed below, however, the downstream decay length of the exponential is related to the flow rate in tubing 16 and to the rate of radial heat transport between the tubing and the surrounding formation. Furthermore, the amplitude of the temperature perturbation also can be related to the flow rate.

Gas-lift injection modifies the temperature profile along a gas-lift well. Both the amplitude and the shape of the perturbation depend on the production fluid flow rate. Accordingly, the temperature perturbation can be measured by, for example, distributed temperature sensor 20 and used to determine flow rate. An automated process of determining such flow rates is illustrated generally in FIGS. 20 and 21.

Referring first to FIG. 20, flow rate can be determined based on the downstream decay length of the temperature perturbation. In this example, temperature data from sensor 20 is input to processor 22, as illustrated in block 174. The temperature data enables evaluation of the decay length of the thermal perturbation at a gas injection location, as illustrated by block 176. Once the decay length is determined, a model relating decay length and flow rate is applied to determine the flow rate of production fluid through tubing 16, as illustrated by block 178.

Similarly and with reference to FIG. 21, flow rate also can be determined based on the amplitude of the temperature perturbation. Again, temperature data from, for example, distributed temperature sensor 20 is input to processor 22, as illustrated by block 180. The temperature data enables determination of the amplitude of the thermal perturbation at a given a gas injection location, as illustrated by block 182. The thermal perturbation data can then be utilized by a model relating amplitude to flow rate to determine the flow rate of production fluid through tubing 16, as illustrated by block 184.

Examples of specific models that can be used to determine the production fluid flow rates are discussed in detail below. However, it should be noted that the processing of measured thermal data according to the models may be carried out on processor 22 or other suitable processing system. Similarly, the mathematical models/algorithms can be stored, for example, at memory 34 or other suitable location.

In applying the model or models to a given set of thermal data, other well related parameters may be incorporated into the modeling to improve the accuracy of the determined flow rates based on the temperature profile. The desirability of incorporating such parameters into application of the model may depend on such factors as gas-lift well environment and gas-lift system design.

Referring generally to FIG. 22, a variety of well related parameters 186, 188, 190, 192 and 194 can be utilized to improve the accuracy of the results when applying a given model, as illustrated by block 196. Examples of such parameters comprise heat capacity of the production fluid 186, thermal conductivity of the surrounding formation 188, thermal history of the well 190, radial heat transport in the well in the surrounding formation 192 (particularly when using the model relating decay length and flow rate) and pressure drop 194 between the annulus and tubing 16 (particularly when using the model relating thermal perturbation amplitude and flow rate).

Whether estimating the flow rate based on the decay length or the amplitude of the thermal perturbation, produced fluid heat capacity is a parameter that often affects quantitative estimates of the production fluid flow rate. It should be noted, however, that the produced fluid can be a mixture of fluids, such as water and oil. The heat capacity per unit mass of water is typically three times as large as that of oil. Consequently, uncertainty in the produced-water fraction causes an equal or larger relative uncertainty in an estimated flow rate. If the produced-water fraction is known from surface measurements, the heat capacity of the fluid may be determined or estimated. Otherwise, the water fraction of the produced fluid can be measured. In some applications, a differential pressure measurement immediately below the gas-injection depth can be used to provide the water fraction, assuming there is no gas at that point.

In the following discussion, embodiments of models are discussed and developed to facilitate an understanding of the ability to determine flow rates based on temperature profiles in gas-lift wells, as graphically illustrated in FIGS. 20 and 21. In these examples, certain assumptions are made about the design of the gas-lift well. Specifically, a vertical well is considered with fluid entering production tubing 16 at the local geothermal temperature. Injected gas flows down the casing/tubing annulus and enters the bottom of tubing 16. Production fluid and the injected gas flow to a surface location through production tubing 16. Furthermore, it is assumed that the axial and radial heat transport in the tubing and annulus are in steady-state, but the radial heat transport in the formation is time dependent. The model can be modified easily to account for an inclined well or gas injection above the bottom of the tubing.

The models utilized are based on heat transport equations and their solutions. A solution strategy is to compute the net axial transport of enthalpy into small segments of the production tubing and annulus and to equate these to the net losses from the segments by radial heat transport. The mathematical basis is established as follows:

$${w}_{a} \frac{ⅆ {H}_{a}}{ⅆ z} = \frac{ⅆ ( {q}_{Fa} - {q}_{at} )}{ⅆ z} \qquad Equation 3$$

The left side of the equation is axial transport of enthalpy, the right side is net radial heat loss. If the continuous Joule-Thompson (JT) effect is ignored, the enthalpy may be replaced with the heat capacity:

$${c}_{ga} \frac{ⅆ {T}_{a}}{ⅆ z} = \frac{ⅆ {H}_{a}}{ⅆ z} = \frac{1}{{w}_{a}} \frac{ⅆ ( {q}_{Fa} - {q}_{at} )}{ⅆ z} \qquad Equation 4$$

The heat flow rate from the annulus to the formation in the interval dz is:

$${q}_{Fa} = {w}_{a} {c}_{ga} ( {T}_{G} - {T}_{a} ) dz / A , \\ A ≡ {w}_{a} {c}_{ga} \frac{{k}_{e} + τ {r}_{c} {U}_{Fa}}{2 π {k}_{e} {r}_{c} {U}_{Fa}} \qquad Equation 5$$

The dimensionless time, τ, accounts for the difference between the local geothermal temperature, Tₑ, and the actual temperature of the formation at the well. The heat flow rate from the tubing to the annulus in the interval dz is:

$${q}_{at} = {w}_{a} {c}_{ga} ( {T}_{a} - {T}_{t} ) dz / B , \\ B ≡ \frac{{w}_{a} {c}_{ga}}{2 π {r}_{t} {U}_{at}} \qquad Equation 6$$

Combining Eq. 4-6, the following is obtained:

$$\frac{ⅆ {T}_{a}}{ⅆ z} = \frac{{T}_{G} - {T}_{a}}{A} + \frac{{T}_{t} - {T}_{a}}{B} \qquad Equation 7$$

In the tubing, a similar derivation results in:

$$\frac{ⅆ {T}_{t}}{ⅆ z} = \frac{{T}_{t} - {T}_{a}}{{B}^{′}} , \\ {B}^{′} ≡ \frac{{w}_{t} {c}_{t}}{2 π {r}_{t} {U}_{at}} \qquad Equation 8$$

Elimination of Tₐ in Eqs. 7 and 8 produces a second order differential equation for the tubing temperature:

$${AB}^{′} \frac{{ⅆ}^{2} {T}_{t}}{ⅆ {z}^{2}} + {B}^{″} \frac{ⅆ {T}_{t}}{ⅆ z} - {T}_{t} + {T}_{es} = 0 , \\ {B}^{″} ≡ {B}^{′} + {AB}^{′} / B - A \qquad Equation 9$$

For a linear geothermal gradient, the solution to Eq. 9 is:
Tₑ=Tₑₛ+g_{G}z,
Tₜ=αe^{λ}^{₁}^{z}+βe^{λ}^{₂}^{z}+g_{G}(B″+z)+Tₑₛ,
Tₐ=(1−λ₁B′)αe^{λ}^{₁}^{z}+(1−λ₂B′)βe^{λ}^{₂}^{z}+g_{G}(B″+z−B′)+Tₑₛ,
λ₁=(\sqrt{B″²+4AB′}−B″)/2AB′,
λ₂=−(B″+\sqrt{B″²+4AB′})/2AB′. Equation 10
It should be noted that λ₁ is positive, and terms involving it are usually important only at the bottom of the well. λ₂ is negative, and terms involving it are usually important only near the surface. The boundary conditions are the inlet temperature of the gas at the surface and the tubing temperature at bottom hole:
wₜcₜT_{tbh}=wₐ(C_{ga}T_{abh}−R)+wₚcₚT_{ebh},
Tₐ(z=0)=Tₐₛ,
wₜ≡wₐ+wₚ,
cₜ≡(wₐc_{ga}+wₚcₚ)/wₜ. Equation 11
The cooling coefficient, R, adds the JT effect at the gas-injection point. Evaluating T_{tbh}, T_{abh} and T_{ebh} from Eq. 10, it can be determined:

$$α = - \frac{( 1 - {λ}_{2} {B}^{′} ) ( {Gg}_{G} {B}^{′} + {DG}^{″} )}{( 1 - {λ}_{2} {B}^{′} ) {G}^{′} - ( 1 - {λ}_{1} {B}^{′} ) {G}^{″}} , \\ β = \frac{( 1 - {λ}_{2} {B}^{′} ) {DG}^{′} + ( 1 - {λ}_{1} {B}^{′} ) {Gg}_{G} {B}^{′}}{( 1 - {λ}_{2} {B}^{′} ) {G}^{′} - ( 1 - {λ}_{1} {B}^{′} ) {G}^{″}} , \\ D ≡ \frac{{T}_{as} - {g}_{G} ( {B}^{″} - {B}^{′} ) - {T}_{es}}{1 - {λ}_{2} {B}^{′}} , \\ G ≡ \frac{{w}_{a} ( R + {c}_{ga} {g}_{G} {B}^{′} ) + {w}_{p} {c}_{p} {g}_{G} {B}^{″}}{{w}_{t} {c}_{t} {g}_{G} {B}^{′}} , \\ {G}^{′} ≡ ( 1 - \frac{{w}_{a} {c}_{ga}}{{w}_{t} {c}_{t}} ( 1 - {λ}_{1} {B}^{′} ) ) {ⅇ}^{{λ}_{1} L} , \\ {G}^{″} ≡ ( 1 - \frac{{w}_{a} {c}_{ga}}{{w}_{t} {c}_{t}} ( 1 - {λ}_{2} {B}^{′} ) ) {ⅇ}^{{λ}_{2} L} . \qquad Equation 12$$

G″/G′ can be neglected. In such approximation, the constants simplify to:

$$\begin{matrix}α ≅ - \frac{{Gg}_{G} {B}^{′}}{{G}^{′}} = - \frac{{w}_{a} ( R + {c}_{ga} {g}_{G} {B}^{′} ) + {w}_{p} {c}_{p} {g}_{G} {B}^{″}}{{w}_{t} {c}_{t} {G}^{′}} , \\ β ≅ \frac{( 1 - {λ}_{2} {B}^{′} ) {DG}^{′} + ( 1 - {λ}_{1} {B}^{′} ) {Gg}_{G} {B}^{′}}{( 1 - {λ}_{2} {B}^{′} ) {G}^{′}} .\end{matrix} \qquad Equation 13$$

Heat transfer coefficients can be estimated from the dimensionless Nusselt number:
Nu_{D}=Ud/k
In laminar flow conditions in a pipe, Nu_{D} is 4.4, and in single-phase turbulent flow, Nu_{D} may be estimated using the Reynolds number and the Prandtl number as follows:
Nu_{D}=0.023Re_{D}^{4/5}Pr″
Re_{D}=ρvd/μ
Pr=cμ/k Equation 14
When the pipe is warmer than the fluid, n is 0.3, otherwise n is 0.4. Also, in the annulus, the diameter d is replaced by the hydraulic diameter 2(r_{c}-rₜ).

By way of example, methane can be used as an injection fluid with gas-lift system 10. Because the viscosity of methane is small, the Reynolds number is usually greater than 10,000. Also, because multi-phase flow enhances turbulence, radial transport in the production tubing is expected to be very efficient. The tubing heat-transfer coefficient is assumed to be much greater than the annulus coefficient. Consequently, the heat transfer between the tubing and the annulus involves only annulus properties. Furthermore, the coefficient for heat transfer between the tubing and the annulus is assumed to equal the coefficient for transfer between the annulus and the formation. That is:

$${U}_{at} = {U}_{Fa} = \frac{0.023 {k}_{g}}{2 ( {r}_{c} - {r}_{t} )} {( \frac{2 {w}_{a}}{π ( {r}_{c} + {r}_{t} ) {μ}_{g}} )}^{4 / 5} \qquad Equation 15$$

In some applications, the mathematical basis of the models can be simplified. Consider first the ratio G′/G″. It is proportional to:
e^{(λ}^{₁}^{-λ}^{₂}^{)L}
The other factors in the ratio are of order unity, and the exponent is:
\sqrt{B″²+4AB′} L/AB′
The exponent is smallest when wₚ can be neglected and wₐ is large. In that case, the first term in the numerator of A can be neglected and the exponent of G′/G″ becomes:
\sqrt{1/A²+4/AB} L
G″ can be neglected when the exponent is greater than 2π, i.e., when:

$${w}_{a} < \frac{L}{{c}_{ga}} \sqrt{{( \frac{{k}_{e}}{τ} )}^{2} + \frac{2 {k}_{e}}{τ} \frac{0.023 {k}_{g} {r}_{t}}{( {r}_{c} - {r}_{t} )} {( \frac{2 {w}_{a}}{π ( {r}_{c} + {r}_{t} ) {μ}_{g}} )}^{4 / 5}} \qquad Equation 16$$

In typical cases, G″ can be neglected when the gas flow rate of, for example, methane is less than 5 kg/s.

For clarification, the nomenclature used herein is as follows:

| | | Units |
|---|---|---|
| Symbol | Meaning | (SI) |
| c | Heat | j/(kg K) |
| | capacity | |
| d | Diameter | m |
| gG | Geothermal | K/m |
| | gradient | |
| H | Enthalpy per | j/kg |
| | unit mass | |
| k | Thermal | w/(Km) |
| | conductivity | |
| L | Gas- | m |
| | injection | |
| | depth | |
| q | Heat | w |
| | transfer rate | |
| r | Radius | m |
| R | JT cooling | j/kg |
| | coefficient | |
| t | Time | s |
| T | Temperature | K |
| U | Heat | w/K |
| | transfer | m² |
| | coefficient | |
| w | Mass flow rate | kg/s |
| z | Depth | m |
| λ | Decay rate | l/m |
| μ | Viscosity | Pa s |
| ν | Mean velocity | m/s |
| ρ | Density | kg/m³ |
| Nu_{D} | Nusselt | none |
| | number | |
| Pr | Prandtl | none |
| | number | |
| Re_{D} | Reynolds | none |
| | number | |
| τ | Dimensionless | none |
| | time | |

Furthermore, the definition of the various subscripts is as follows:

a—annulus; bh—bottom hole; c—casing; e—Earth; F—formation; g—gas; G—geothermal; p—production fluid; s—surface of Earth; t—inside tubing.

To estimate flow rate from the amplitude, the thermal discontinuity is first determined from the temperature profile and then the following equation is solved for flow rate:

$${T}_{tbh} - {T}_{ebh} ≅ - \frac{{w}_{a} R + {w}_{a} {c}_{ga} {g}_{G} {B}^{′} ( 1 - {λ}_{1} {B}^{″} )}{{w}_{p} {c}_{p} + {w}_{a} {c}_{ga} {λ}_{1} {B}^{′}} \qquad Equation 17$$

In this example, the second term in Eq. 10 for Tₜ has been neglected, because the exponential factor suppresses it near the bottom of the well. In many cases, the second terms in the numerator and the denominator of Eq. 17 are much smaller than the first terms. The discontinuity is approximately equal to the total cooling power divided by the flow rate and heat capacity of the production fluid. The effect of the heat capacity of the gas is reduced in Eq. 17 because gas is cooled as it approaches the injection point from above. It should further be noted the solution of Eq. 17 is possible when all injected gas is injected through a single orifice and the total gas flow rate is known. In this application, the solution is insensitive to Earth properties and thermal history. However, the cooling coefficient, which depends on the gas properties and the pressure difference between the annulus and the tubing at the injection depth, is needed for the solution. The pressure change in the annulus from the surface to the injection depth is small, because the gas density is comparatively low and the frictional pressure gradient counteracts the gravitational gradient. Thus, the annulus pressure at depth may be estimated accurately, and the tubing pressure is measured.

To determine the flow rate from the decay length of the thermal perturbation produced by gas injection, the decay length is first obtained from the temperature profile. Then, flow rate may be determined by solving for λ₁ of Eq. 10. However, the solution depends on several parameters, including heat capacity of the produced fluid and radial heat transport in the well. Additionally, the dimensionless time τ in the parameter A depends on the earth's thermal diffusivity and the thermal history of the well. An approximation to the analytical solution of the diffusion equation uses a constant heat flux. When the time t is much greater than ρₑcₑr_{c}²/kₑ (typically a few hours), analytical solutions for different boundary conditions become indistinguishable. Therefore, details of distant thermal history of the well can be ignored, but recent history can be important. Accurate flow-rate estimates can benefit from a numerical solution of the diffusion equation with the measured temperature history as the boundary condition.

By way of further explanation, the decay length of the Joule-Thompson cooling perturbation is 1/λ₁. During normal production, the total heat capacity of the production fluid is much greater than the total heat capacity of the injected gas, i.e., B′>>B. In this approximation, the decay length is:

$$1 / {λ}_{1} ≅ \frac{{w}_{t} {c}_{t}}{2 π {r}_{t} {U}_{at}} + \frac{{w}_{p} {c}_{p}}{2 π {r}_{c} {U}_{Fa}} + \frac{{w}_{p} {c}_{p} τ}{{k}_{e}} \qquad Equation 18$$

The first term is the effect of heat transfer between the tubing and the annulus. The other terms are the effect of heat transfer between the annulus and the formation. Important factors are the total heat capacity of the production fluid, the heat transfer coefficients and the dimensionless time.

Accordingly, the mathematical models discussed above can be used to determine flow rates in a gas-lift well based on either or both the decay length and the amplitude of the injection-induced thermal perturbation. Other parameters also can be useful in improving the accuracy of the determined flow rate. For example, heat capacity of the production fluid can be important when relying on either decay length models or amplitude models. When using an amplitude model, it can be important to measure the pressure drop between the annulus and the tubing. When using a decay length model, it often is helpful to determine the radial heat transport in both the well and the surrounding formation. Furthermore, in the embodiments described, the temperature data collection, application of a model to the temperature data, and the determination of flow rates are conducted on processor system 22. A variety of a graphical displays or other output formats may be displayed on output device 38 to convey flow rate information to a system operator.

In another embodiment, the gas lift performance of a well can be optimized by utilizing the downhole fluid flow rates determined through the temperature data obtained, for example, via distributed temperature sensor 20. Gas injected into many gas-lift applications is not within an optimal range due to, for example, operators injecting too much gas into the wellbore. The algorithms discussed above for determining flow rate in a gas-injection well can be used in the present embodiment to determine fluid flow rates. Additionally, the algorithms can be adjusted to provide a feedback loop that enables automatic changes to the gas injection rate and computation of the optimal amount of gas injection to maximize the fluid flow rate.

Referring generally to FIG. 23, the general methodology is illustrated in flow chart form. Initially, a flow rate of the produced fluid is determined based on one or more wellbore parameters (see block 198). Subsequently, an analysis is performed as to whether the flow rate is in an optimal range (see block 200). In this embodiment, the analysis is performed automatically via, for example, processor 22. The optimal range can be determined in a variety of ways, including use of data from similar wells, use of historical data from the well being analyzed or by adjusting the gas injection rate and tracking whether the production fluid flow rate is increasing or decreasing. If the processor determines the flow rate is not optimized, an action is taken, e.g. changing the gas injection rate, to adjust the flow rate (see block 202). Following adjustment, the new fluid flow rate is again determined (see block 198) and the process is repeated.

As discussed above with reference to FIGS. 19-22, the flow rate of fluid produced through production tubing 16 can be obtained from temperatures measured along the wellbore. As illustrated in FIG. 24, the fluid flow rate is modeled via a specific well model/algorithm that relates temperature to the production fluid flow rate through tubing 16 (see block 204). After establishing the suitable model, temperatures are measured along the well (see block 206). A distributed temperature sensor, such as the distributed temperature sensor 20 discussed above, works well to obtain a temperature profile that can automatically be provided to processor 22. The measured temperatures are applied to the well model (see block 208) which uses those measured temperatures to determine a fluid flow rate of the production fluid (see block 210). In this embodiment, however, the model/algorithm is expanded to automatically optimize that fluid flow rate.

Processor 22 can be used in a closed loop feedback system to facilitate this flow rate optimization by continually analyzing whether the flow rate is within a determined optimal range. Specifically, upon determining a fluid flow rate, the algorithm performs a first test 212 and checks to see if the fluid flow rate through the production tubing is too fast, e.g. above the optimal range. If the flow rate is too fast, processor 22 acts to decrease the fluid flow rate (see block 214) by, for example, decreasing the flow of injection gas. The process is then returned to block 206 to once again measure temperatures along the well for determining the new flow rate. If, however, the first test 212 does not detect a fluid flow that is too fast, a second test 216 checks to see if the flow rate is too slow. If the flow rate is too slow, processor 22 acts to increase the fluid flow rate (see block 218) by, for example, increasing the gas injected. The process is then returned to block 206 to again measure temperatures along the well for determining the new flow rate. When second test 216 is performed and the fluid flow rate in the production tubing is not too slow, then the flow rate is in the optimal range and the process is returned to block 206 for subsequent checking of the fluid flow rate. Thus, use of the algorithms discussed above can be automated to continually check and optimize the production fluid flow rate.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method for analyzing distributed temperature data from a well, comprising:
obtaining temperature profile data along a portion of a wellbore;
providing the temperature profile data to a processor; and
automatically processing the temperature profile data to highlight valuable information to a user.

2. The method as recited in claim 1, wherein automatically processing comprises removing noise from the temperature profile data.

3. The method as recited in claim 1, wherein automatically processing comprises removing low order spatial trends.

4. The method as recited in claim 1, wherein automatically processing comprises utilizing a high-pass filter.

5. The method as recited in claim 1, wherein automatically processing comprises utilizing a low-pass filter.

6. The method as recited in claim 1, wherein automatically processing comprises applying a model-fitting algorithm to the data.

7. The method as recited in claim 6, wherein applying a model-fitting algorithm comprises selecting regions for fitting and fitting a model to data.

8. The method as recited in claim 7, wherein applying a model-fitting algorithm further comprises testing results for statistical significance.

9. The method as recited in claim 6, wherein applying a model-fitting algorithm comprises constructing a match filter and using extrema of a convolution of the filter with data to select candidate depths.

10. The method as recited in claim 9, wherein constructing a match filter comprises incorporating modifications to the filter to make it orthogonal to background trends.

11. The method as recited in claim 1, wherein automatically processing comprises trend removal and filtering of the temperature profile data.

12. The method as recited in claim 1, wherein obtaining comprises utilizing a distributed temperature sensor.

13. The method as recited in claim 1, wherein obtaining comprises deploying an optical fiber in the wellbore.

14. The method as recited in claim 1, wherein obtaining comprises obtaining the temperature profile data with a temporary distributed temperature sensor installation.

15. The method as recited in claim 1, wherein obtaining comprises obtaining the temperature profile data with a slickline distributed temperature sensing system.

16. The method as recited in claim 1, wherein automatically processing comprises utilizing a match filter.

17. The method as recited in claim 16, wherein the match filter is used to detect particular temperature signals corresponding to a particular downhole event.

18. The method as recited in claim 17, wherein the downhole event comprises the location of a gas lift valve.

19. The method as recited in claim 17, wherein the downhole event comprises a hole in a tubing.

20. The method as recited in claim 17, wherein the downhole event comprises a leak in a wellbore completion tool.

21. The method as recited in claim 1, wherein the automatically processing occurs in real-time with the obtaining data.

22. A system to analyze distributed temperature data from a well, comprising:
a distributed temperature sensor adapted to measure temperature profile data along a portion of a wellbore;
a processor adapted to receive the temperature profile data; and
wherein the processor automatically processes the temperature profile data to highlight valuable information to a user.

23. The system as recited in claim 22, wherein the distributed temperature system comprises an optical fiber.

24. The system as recited in claim 22, wherein the distributed temperature sensor comprises an opto-electronic unit to launch optical pulses downhole.

25. The system as recited in claim 24, wherein the opto-electronic unit is coupled to the processor by a communication link.

26. The system as recited in claim 25, wherein the communication link comprises a hardline link.

27. The system as recited in claim 25, wherein the communication link comprises a wireless link.

28. The system as recited in claim 22, wherein the processor is embodied in a portable computer.

29. The system as recited in claim 23, further comprising a production tubing deployed in the wellbore with the optical fiber.

30. The system as recited in claim 29, wherein the production tubing is combined with a gas lift system.

31. A method of detecting certain events within a well, comprising:
obtaining data over a period of time along a portion of a wellbore;
automatically processing the data to detect specific events related to heat energy in the well; and
displaying results to a user.

32. The method as recited in claim 31, wherein obtaining data comprises obtaining temperature data along the portion of the wellbore.

33. The method as recited in claim 32, wherein obtaining temperature data comprises utilizing a distributed temperature sensor.

34. The method as recited in claim 31, wherein automatically processing comprises processing the data on a processor-based computer.

35. The method as recited in claim 31, wherein automatically processing comprises processing backscattered light signals.

36. The method as recited in claim 31, wherein automatically processing comprises applying a model-fitting algorithm to the data.

37. The method as recited in claim 36, wherein applying a model-fitting algorithm comprises selecting regions for fitting and fitting a model to data.

38. The method as recited in claim 37, wherein applying a model-fitting algorithm further comprises testing results for statistical significance.

39. The method as recited in claim 36, wherein applying a model-fitting algorithm comprises constructing a match filter and using extrema of a convolution of the filter with data to select candidate depths.

40. The method as recited in claim 39, wherein constructing a match filter comprises incorporating modifications to the filter to make it orthogonal to background trends.

41. The method as recited in claim 31, wherein automatically processing comprises applying a phenomenological model to the data.

42. The method as recited in claim 31, wherein automatically processing comprises detecting particular temperature signals corresponding to a particular downhole event.

43. The method as recited in claim 31, wherein automatically processing comprises detecting particular temperature signals corresponding to location of a gas lift valve.

44. The method as recited in claim 31, wherein automatically processing comprises detecting particular temperature signals corresponding to a wellbore completion tool leak.

45. The method as recited in claim 31, wherein automatically processing comprises detecting particular temperature signals corresponding to a hole in a production tubing.

46. The method as recited in claim 31, wherein displaying comprises displaying results in graphical form on a display monitor.

47. The method as recited in claim 31, wherein automatically processing comprises utilizing a match filter.

48. The method as recited in claim 31, wherein automatically processing occurs real-time with the obtaining data.

49. A method of determining a flow rate, comprising:
providing a well model relating temperature characteristics to a flow rate of a production fluid in a well having a gas lift system;
measuring temperatures along the well; and
determining the flow rate based on applying the well model to measured temperature data.

50. The method is recited in claim 49, wherein determining comprises determining the flow rate based on a decay length of a thermal perturbation at a gas injection location.

51. The method as recited in claim 49, wherein determining comprises determining the flow rate based on a measured amplitude of a thermal discontinuity at a gas injection location.

52. The method as recited in claim 49, further comprising estimating the heat capacity of the production fluid and using the heat capacity estimate in the well model.

53. A method, comprising:
measuring a temperature profile in a well having a gas lift system to produce a fluid through a production tubing; and
determining a flow rate through the production tubing based solely on the temperature profile and established well parameters.

54. The method as recited in claim 53, further comprising obtaining the established well parameters.

55. The method as recited in claim 54, wherein obtaining comprises establishing a heat capacity of the fluid.

56. The method as recited in claim 54, wherein obtaining comprises establishing a radial heat transport value in the well.

57. The method as recited in claim 54, wherein obtaining comprises establishing a thermal conductivity of a surrounding well formation.

58. The method as recited in claim 54, wherein obtaining comprises establishing a thermal history of the well.

59. The method as recited in claim 53, wherein measuring comprises measuring the temperature profile with a distributed temperature sensor.

60. The method as recited in claim 53, wherein determining comprises determining the flow rate based on a decay length of a thermal perturbation at a gas injection location.

61. The method as recited in claim 53, wherein determining comprises determining the flow rate based on a measured amplitude of a thermal discontinuity at a gas injection location.

62. The method as recited in claim 53, further comprising processing the temperature profile according to a stored model relating the temperature profile to the flow rate.

63. A method of determining a flow rate, comprising:
providing a well model relating flow rate of a production fluid to a decay length of a thermal perturbation at a gas injection location;
measuring temperatures along the well; and
applying the well model to the measured temperatures to determine the flow rate based on the decay length of the thermal perturbation.

64. The method as recited in claim 63, wherein providing comprises developing the well model to utilize a heat capacity of the production fluid.

65. The method as recited in claim 63, wherein providing comprises developing the well model to utilize a radial heat transport value of the well.

66. The method as recited in claim 63, wherein providing comprises developing the well model to utilize a thermal conductivity of a surrounding formation.

67. The method as recited in claim 63, wherein providing comprises developing the well model to utilize a thermal history of the well.

68. A method of determining a flow rate, comprising:
providing a well model relating flow rate of a production fluid to a measured amplitude of a thermal perturbation at a gas injection location;
measuring temperatures along the well; and
applying the well model to the measured temperatures to determine the flow rate based on the measured amplitude of the thermal perturbation.

69. The method as recited in claim 68, wherein providing comprises developing the well model to utilize a heat capacity of the production fluid.

70. The method as recited in claim 68, wherein providing comprises developing the well model to utilize a pressure drop between an annulus and a production tubing.

71. The method as recited in claim 68, wherein measuring comprises utilizing a distributed temperature sensor.

72. The method as recited in claim 68, wherein applying comprises applying the well model to the measured temperatures on a processor system.

73. A system, comprising:
a temperature sensor system deployed with a gas lift system in a well to measure temperature in a plurality of locations along the well; and
a processor system able to receive the measured temperatures and apply the measured temperatures to a stored model, the stored model being able to establish a fluid flow rate of a produced fluid based on a thermal perturbation at a gas injection location of the gas lift system.

74. The system as recited in claim 73, wherein the temperature sensor system comprises a distributed temperature sensor.

75. The system as recited in claim 73, wherein the stored model establishes the fluid flow rate based on a decay length of the thermal perturbation.

76. The system as recited in claim 73, wherein the stored model establishes the fluid flow rate based on a measured amplitude of the thermal perturbation.

77. The system as recited in claim 73, wherein the well model utilizes an established well parameter to improve the accuracy of the determined fluid flow rate for a given well.

78. The system as recited in claim 77, wherein the established well parameter comprises a heat capacity of the produced fluid.

79. The system as recited in claim 77, wherein the established well parameter comprises a radial heat transport value of the well.

80. The system as recited in claim 77, wherein the established well parameter comprises a thermal conductivity of a surrounding formation.

81. The system as recited in claim 77, wherein the established well parameter comprises a thermal history of the well.

82. A system, comprising:
means for measuring a temperature profile in a well having a gas lift system to produce a fluid through a production tubing; and
means for determining a flow rate through the production tubing based solely on the temperature profile and established well parameters.

83. The system as recited in claim 82, wherein the means for measuring comprises a distributed temperature sensor.

84. The system as recited in claim 82, wherein the means for determining comprises a model relating a thermal perturbation to a flow rate of the fluid.

85. A method of determining a flow rate, comprising:
providing a well model relating temperature characteristics to a flow rate of a production fluid in a well;
measuring temperatures along the well; and
determining the flow rate based on applying the well model to measured temperature data.

86. A method, comprising:
measuring a temperature profile in a well having a gas lift system to produce a fluid through a production tubing;
determining a flow rate through the production tubing based on the temperature profile and established well parameters; and
automatically optimizing the flow rate.

87. The method as recited in claim 86, wherein measuring comprises measuring the temperature profile with a distributed temperature sensor.

88. The method as recited in claim 86, wherein automatically optimizing comprises changing a gas injection rate.

89. The method as recited in claim 86, wherein determining comprises determining the flow rate based on a decay length of a thermal perturbation at a gas injection location.

90. The method as recited in claim 86, wherein determining comprises determining the flow rate based on a measured amplitude of a thermal discontinuity at a gas injection location.

91. A system, comprising:
a distributed temperature sensor deployed with a gas lift system in a well to obtain a temperature profile along the well; and
a processor system able to receive the measured temperatures and apply the measured temperatures to a stored model, the stored model being able to establish a fluid flow rate of a produced fluid and to automatically optimize the fluid flow rate.

92. The system as recited in claim 91, wherein the stored model establishes the fluid flow rate based on a decay length of a thermal perturbation along the gas lift system.

93. The system as recited in claim 91, wherein the stored model establishes the fluid flow rate based on a measured amplitude of a thermal perturbation along the gas lift system.

94. The system as recited in claim 91, further comprising utilizing an established well parameter to improve the accuracy of the fluid flow rate determined for a given well.
